(19) United States
(12) Patent Application Publication
(10) Pub. No.: US 2009/0091172 A1
(43) Pub. Date: Apr. 9, 2009

(54) APPARATUS FOR ADJUSTING LENGTH OF SEAT CUSHION

(76) Inventor: Sang Ho Kim, Incheon (KR)

Correspondence Address: MORGAN, LEWIS & BOCKIUS LLP (SF), One Market, Spear Street Tower, Suite 2800, San Francisco, CA, 94105, US

(21) Appl. No.: 11/967,537

(22) Filed: Dec. 31, 2007

(30) Foreign Application Priority Data
Oct. 5, 2007 (KR) 10-2007-0100159

(51) Int. Cl. B60N 2/02

(52) U.S. Cl. 297/337

(57) ABSTRACT

An apparatus for adjusting the length of a seat cushion comprises an extension panel, installed on a cushion panel of the seat cushion and spaced apart from the cushion panel. Adjusting units are installed between the cushion panel and the extension panel, and move the extension panel in a forward or backward direction. Bach adjusting unit includes a reversible motor, a carrier, fixed to one side of the extension panel and movable in a forward or backward direction, a slider, fixed to a lower surface of the extension panel and movable together with the extension panel in a forward or backward direction, and a rail fixed to the cushion panel, to and support and guide the slider.

### CROSS-REFERENCE TO RELATED APPLICATIONS

This application claims priority to Korean Application No. 10-2007-0100159, filed on Oct. 5, 2007, the disclosure of which is incorporated herein by reference.

### BACKGROUND OF THE INVENTION

1. Field of the Invention

The present invention relates to an apparatus for adjusting the length of a seat cushion in a vehicle.

2. Description of the Prior Art

Typically, a seat cushion installed in a vehicle has a fixed longitudinal length, which cannot be adjusted. Since people have different physical characteristics of height, hip size, leg length, and so forth, the impossibility of adjusting the length of the seat cushion can give considerable discomfort to certain occupants. In particular, in the case in which the thighs of the occupant are not uniformly supported because the seat cushion is short, the blood does not freely flow in the legs, causing numbness.

An attempt to solve this problem has included air cells into which air can be injected or released to change the seat cushion length. However, such an apparatus for adjusting the length of the seat cushion has poor responsiveness due to the time taken in the process of supplying and removing the air, and a high possibility of the air cells being damaged by a sharp object.

### SUMMARY OF THE INVENTION

Embodiments of the present invention provide an apparatus for adjusting the length of a seat cushion for an automotive seat, which is able to adjust the length of the seat cushion so that it is suitable for the physical characteristics of an occupant, and particularly, has good responsiveness and a low possibility of being damaged.

According to an exemplary embodiment of the present invention, there is provided an apparatus for adjusting the length of a seat cushion for an automotive seat, which comprises an extension panel, which is installed on a cushion panel of the seat cushion spaced apart from the cushion panel; and adjusting units, which are installed between the cushion panel and the extension panel, and move the extension panel in a forward or backward direction. Each adjusting unit may include: a reversible motor; a carrier, which is fixed to one side of the extension panel, and is movable in a forward or backward direction by means of driving force of the reversible motor; a slider, which is fixed to the lower surface of the extension panel, and is movable together with the extension panel in a forward or backward direction; and a rail, which is fixed to the cushion panel, and supports and guides the slider.

The forward or backward movement of the carrier maybe performed using a lead screw, which is connected to a rotational shall of the reversible motor and is movable in a forward or backward direction when the reversible motor is driven.

The slider is preferably supported or guided by the rail at one or more positions. For example, in a first configuration, the slider, to which a load is transmitted from the extension panel, has to be directly supported and guided by the rail. In a second configuration, when an excessive load is transmitted to the slider, the rail needs to support and/or guide the slider.

In conjunction with the first configuration, preferably, the slider and the rail include racks, and the slider moves in a forward or backward direction along the rail via a pinion interposed between the racks. This combination of the rack and the pinion not only guarantees the smooth reciprocation of the slider on the rail, but also performs well in supporting the load transmitted from the extension panel to the slider.

In conjunction with the second configuration, preferably, the slider includes a sliding part protruding on one side thereof and the rail includes a support that extends along a locus of the sliding part in a forward or backward direction and is spaced apart from the sliding part by a predetermined interval. In the case in which an excessive load is transmitted to the slider, the slider can be supported by this support.

The adjusting unit may be installed on opposite sides of the extension panel, and the pinion bar, on opposite ends of which pinions are provided, can be installed between the adjusting units.

According to the structure of this apparatus for adjusting the length of a seat cushion, as the extension panel moves in a forward or backward direction, the length of the seat cushion can be adjusted. However, in the case in which the extension panel moves in the forward direction, a seat cover, covering the extension panel, also extends. For the purpose of a smart seat, when the extension panel returns to its original position, the seat cover preferably returns to its original position as well.

To this end, the pinion bar is used. More specifically, the pinion bar is fixed to one end of the seat cover such that the seat cover can be wound around or unwound from the outer surface of the pinion bar, which is rotated. In the case in which the extension panel moves in the forward direction, the seat cover must be unwound. In contrast, in the case in which the extension panel moves in the backward direction, the seat cover must be wound.

The pinions of the opposite ends of the pinion bar may include a first pinion engaged with the rack of the slider, and a second pinion engaged with the rack of the rail, and the rotational ratios of these pinions may be different from each other. The moving speed of the extension panel and the winding/unwinding speed of the seat cover are set to be different so that the seal cover can be prevented from incompletely returning to its original position even though the extension panel is returned to its original position. In the case in which the seat cover is not properly wound around the pinion bar, the seat cover is unwound and exposed to the outside. Thus, the seat has a poor appearance. Meanwhile, the first pinion can be rotated together with or independent of the second pinion using known technology.

According to the apparatus for adjusting the length of a seat cushion for an automotive seat, the length of the seat cushion can be adjusted to be suitable for the physical characteristics of an occupant.

Further, the length of the seat cushion is mechanically adjusted by the operation of the motor, so that good responsiveness and a low possibility of damage can be realized.

In addition, the speed at which the length of the seat cushion is adjusted and the speed at which the seat cover is wound and unwound can be independently adjusted, so that it is easy to prevent the appearance of the seat from being spoiled by incomplete winding or unwinding of the seat cover.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIGS. 1 and 2 are conceptual views illustrating an apparatus for adjusting the length of a seat cushion for an automotive seat according to the present invention, wherein FIG. 1 shows the seat cushion before the length is increased, and FIG. 2 shows the seat cushion alter the length is increased;

FIG. 3 is a schematic view illustrating the example of an apparatus for adjusting the length of a seal cushion according to the present invention;

FIG. 4 is a schematic view illustrating a configuration in which extension panel, a motor, a carrier and a bracket have been excluded from the apparatus for adjusting the length of a seat cushion, as illustrated in FIG. 5;

FIG. 5 is a view illustrating the apparatus for adjusting the length of a seat cushion as illustrated in FIG. 4 when viewed from a different angle;

FIG. 6 is a view illustrating another example of the pinion bar in an apparatus for adjusting the length of a seat cushion for an automotive seat according to the present invention; and

FIG. 7 is a view explaining how a seat cover is wound by the pinion bar of FIG. 6.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to a exemplary embodiments of the present invention as illustrated in the accompanying drawings and described below. While the invention will be described in conjunction with exemplary embodiments, it should be understood that the description is not intended to limit the invention to the exemplary embodiments. On the contrary, the invention is intended to cover not only the exemplary embodiments, but also various alternatives, modifications, equivalents and other embodiments, which may be included within the spirit and scope of the invention as defined by the appended claims.

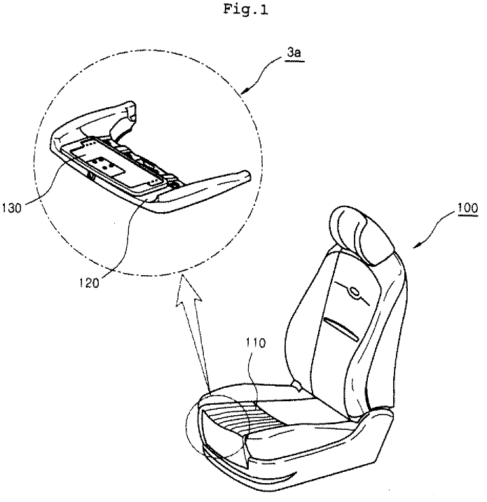

As illustrated in FIGS. 1 and 2, an extension panel 130 is installed on the front end of a cushion panel 120 of the seat cushion 110. As the extension panel 130 moves in a forward or backward direction, the length of the seat cushion 110 is adjusted. Each circled part, indicated by reference numbers 3a and 4a in FIGS. 1 and 2, shows the cushion panel 120 and the extension panel 130. A reference number 111, which is not yet described, is a length extension of the seat cushion 110.

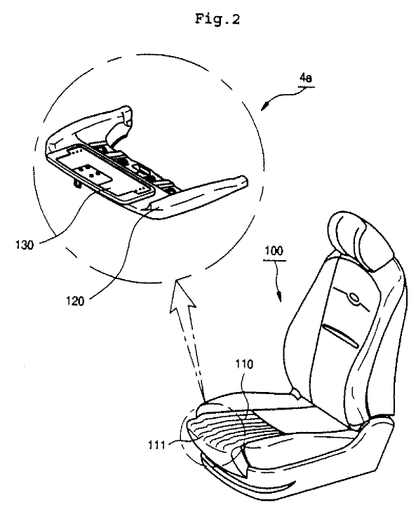

In FIG. 3, the apparatus for adjusting the length of a seat cushion according to an exemplary embodiment of the invention is illustrated in more detail. As illustrated in FIG. 3, an adjusting apparatus comprises the extension panel 130 and adjusting units.

The extension panel 130 is installed on the front end of a cushion panel 120 and is spaced apart from the cushion panel 120. The extension panel can be moved in a forward or backward direction by means of the adjusting units.

The adjusting units are installed between the cushion panel 120 and the extension panel 130. The adjusting units arc also installed opposite each other on left and right sides of the cushion panel 120, so that they not only allow the extension panel 130 to move forward and backward but also support the weight of the occupant, which is transmitted from the extension panel 130. Each adjusting unit basically comprises a motor 10, a carrier 20, a slider 30 and a rail (not shown).

The motor 10 may be a reversible motor that can be rotated in a forward or reverse direction. A lead screw 11 is installed at the rear end of the motor 10 in a direction perpendicular to the rotational shaft (not shown) of the motor 10. The lead screw 11 can move in a forward or backward direction when the rotational shaft of the motor 10 is rotated. To this end, a typical mechanical element, such as a worm gear can be applied. A front end of the lead screw 11 is fixed to the carrier 20.

The carrier 20 functions to transmit the movement of the lead screw 11 to the extension panel 130, and includes an upper part 21, which is fixed to the extension panel 130 by, for example, rivets 21a, and a bent part 22, which is fixed to the lead screw 11. As the lead screw 11 moves, the carrier 20 moves as well. Thus, the extension panel 130 also moves.

The slider 30 is installed under the lower surface of the lateral end of the extension panel 130, and slides together with the extension panel 130 in a forward or backward direction. The slider 30 includes an upper part 31 that is fixed to the extension panel 130 by, for example, rivets 31a and a lower part 33, the inner side of which is fixed to an upper rack 50. The lower part 33 of the slider 30 is provided with a sliding part 34 on the outer side thereof. The sliding part 34 is bent adjacent to the neck 32 of the slider 30 in a downward direction at the upper end thereof, and is fixed to the lower part 33 of the slider at the lower end thereof.

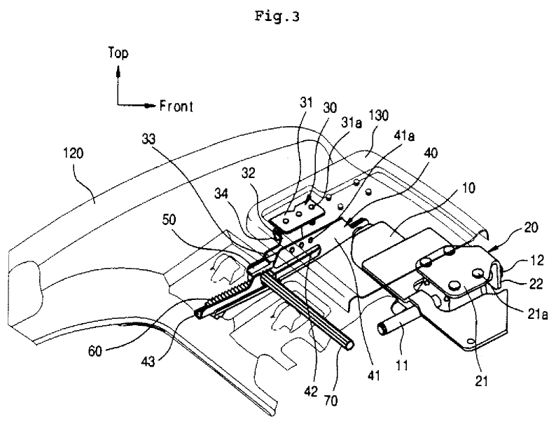

A lower rack 60, shown in FIG. 4, is installed to the rail via a bracket 40 corresponding to the upper rack 50 fixed to the slider 30. A pinion bar 79 is interposed between the upper rack 50 and the lower rack 60 so as to make it easy to move the slider 30 in a forward or backward direction. The rail is fixed to the cushion panel 120, so that a load transmitted to the slider 30 can be supported by the lower rack 60.

The bracket 40 includes a vertical part 41, which is fixed to the rail by, for example, rivets 41a OR other fasteners, and a horizontal part 43, which is fixed to the lower rack 60. The horizontal part 41 is provided with a long sliding slot 42, which extends in a horizontal direction, so as not to interfere with the pinion bar 71 installed in the transverse direction of the cushion panel 120.

In FIG. 3, only the left-hand end of the pinion bar 70 is illustrated. Like the left-hand end, the right-hand of the pinion bar 70 is interposed between the upper rack and the lower rack. The pinion bar 70 interconnects the adjusting units installed on the left and right sides of the cushion panel 120, and is rotated in a forward or reverse direction as the extension panel 130 moves in a forward or backward direction.

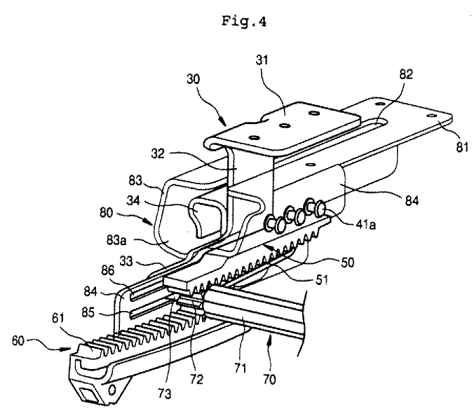

The structure of a rail 80 and the operation between the slider 30 and the rail 80 will be described in detail with reference to FIGS. 4 and 5.

Although not illustrated in defeat in FIGS. 4 and 5, the rail 80 is fixed to the cushion panel. This rail 80 includes an upper part 81 and opposite outer and inner parts 83 and 84. The upper part 81 is provided with a long guide slot 82 such that the neck 32 of the slider 30 can move in a forward or backward direction. The outer part 83 is formed with a U-shaped support 83a, and the inner part 84 is coupled with the bracket by, for example, rivets 41a. The inner part 84 of the rail is provided with two sliding slots 85 and 86 in a longitudinal direction.

The sliding part 34 of the slider 30 is located above the support 83a installed on the outer part 83 of the rail. However, the sliding part 34 is disposed apart from the support 83a by a predetermined interval such that the reciprocation of the slider 30 is not inhibited due to friction between the sliding part 34 and the support 83a. In the case in which an excessive load is concentrated on the extension panel 130, the support 83a serves to support the sliding part 34, that is, the slider 30, to prevent the adjusting apparatus from being damaged.

The pinion bar 70 is provided with a pinion 72, which is disposed between the upper rack 50 and the lower rack 60, at one end thereof. An outer leading end 73 of the pinion 72 passes through a first sliding slot 85 of the rail 80, and then through a through-hole 33a formed in the lower part 33 of the slider. The first sliding slot 85 is adapted so that the pinion bar 70, which rotates in a forward or reverse direction and simultaneously reciprocates in a forward or backward direction as the slider 30 reciprocates in a forward or backward direction, does not interfere with the rail 80. It should be noted that one pinion 72 is engaged with the upper rack 50 and the lower rack 60. Reference numbers 51 and 61, which are not yet described, indicate gears.

As described above, the upper rack 50 is fixed to the lower part 33 of the slider. However, the lower part 33 of the slider is disposed outside the inner part 84 of the rail, and the upper rack 50 is disposed inside the inner part 84 of the rail. Thus, it is necessary for a connector 32a, which connects the lower part 33 of the slider with the upper rack 50, to avoid interfering with the inner part 84 of the rail. To this end, a second sliding slot 86 of the inner part 84 of the rail is provided.

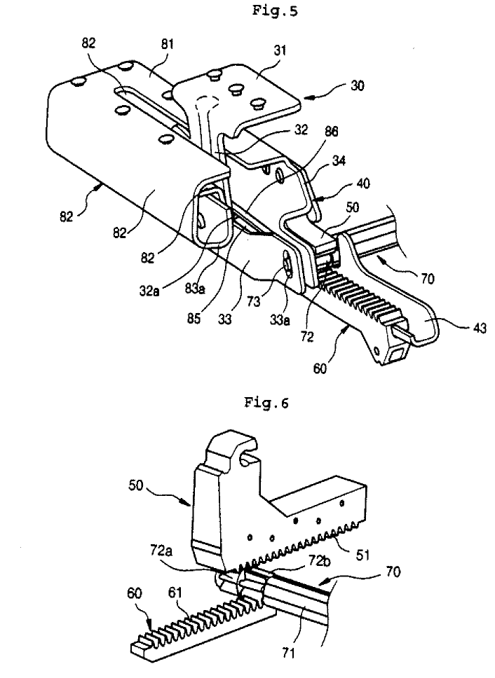

The pinion bar 70, having pinions 72a and 72b, which are structurally different from the above-mentioned pinion, is illustrated in FIG. 6.

As illustrated in FIG. 6, the pinion bar 70 can be provided with two pinions 72a and 72b on opposite ends thereof. In this case, the first pinion 72a is engaged with the upper rack 50, while the second pinion 72b is engaged with the lower rack 60. Furthermore, the two pinions 72a and 72b have different rotational ratios. According to this structure of the pinions, the speed at which the length of the seal cushion is adjusted can be different from the speed at which the seat cover is wound or unwound.

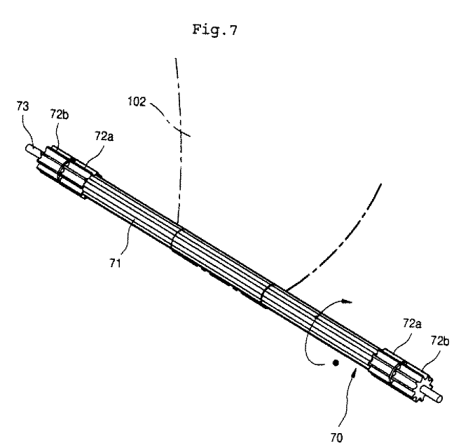

How the seat cover is wound and unwound will be described with reference to FIG. 7.

As illustrated in FIG. 7, one end of the seat cover is fixed to an intermediate part 71 of the pinion bar 70, so that the seat cover is wound and unwound by the rotation of the pinion bar 70. When the length of the seat cushion is increased the seat cover is unwound from the pinion bar 70. The seal cover should not inhibit the extension panel from moving in a forward direction. When the length of the seal cushion returns to its original state, the seat cover should be wound around the pinion bar 70.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for adjusting a length of a seat cushion, comprising:
an extension panel, installed on a cushion panel of a seat cushion and spaced apart from the cushion panel; and
adjusting units installed between the cushion panel and the extension panel, to move the extension panel in a forward or backward direction,
wherein each adjusting unit includes:
a reversible motor;
a carrier fixed to one side of the extension panel, and movable in a forward or backward direction by means of driving force of the reversible motor;
a slider fixed to a lower surface of the extension panel, movable together with the extension panel in a forward or backward direction; and
a rail, fixed to the cushion panel support and guide the slider.

2. The apparatus according to claim 1, wherein the forward or backward movement of the carrier is performed by a lead screw, connected to a rotational shaft of the reversible motor and movable in a forward or backward direction when the reversible motor is driven.

3. The apparatus according to claim 1, wherein the slider is supported and guided by the rail at one or more positions.

4. The apparatus according to claim 1, wherein the slider and the rail include racks, and the slider moves in a forward or backward direction along the rail via a pinion interposed between the racks.

5. The apparatus according to claim 4, wherein the adjusting unit are installed on opposite sides of the extension panel, and the pinion bar, on opposite ends of which pinions are provided, is installed between the adjusting units.

6. The apparatus according to claim 5, wherein the pinions of the pinion bar include a first pinion, engaged with the rack of the slider, and a second pinion, engaged with the rack of the rail, and rotational ratios of these pinions are different from each other.

7. The apparatus according to claim 5, wherein the pinion bar is fixed to one end of a seat cover, which covers the cushion panel and the extension panel, and the seat cover is wound around or unwound from an outer surface of the pinion bar, which is rotated.

8. The apparatus according to claim 4, wherein the slider includes a sliding part protruding from one side thereof, and the rail includes a support that extends along a locus of the sliding part in a forward or backward direction and is spaced apart from the sliding part by a predetermined interval.
